(19) United States
(12) Patent Application Publication
(10) Pub. No.: US 2011/0006990 A1
(43) Pub. Date: Jan. 13, 2011

(54) METHOD AND SYSTEM FOR COMMUNICATING A SIGNAL CORRESPONDING TO A MESSAGE TO AN INPUT/OUTPUT DEVICE

(76) Inventors: Benjamin Abraham, Cupertino, CA (US); Yancy Chen, Campbeli, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/922,200

(22) PCT Filed: Apr. 7, 2008
(86) PCT No.: PCT/US08/59533

§ 371 Date: Sep. 13, 2010

(51) Int. Cl. G06F 3/033; G06F 15/16; G06F 13/42

(52) U.S. Cl. 345/163; 709/206; 710/106

(57) ABSTRACT

A method and system communicate a signal correspond to a message to an input/output device, such as a messaging mouse, and activate a colored light so that a user can be notified of the arrival of an important message even when he is away from the computer desk or when the computer's screen is blanked or off. The color of the light may be associated with a certain message. If a few concurrent messages arrive, the colors associated with these messages can sequentially change in a cyclic order. The colored light continues to shine until the user activates a reset.

### BACKGROUND

Messaging communication is becoming more and more important, sometime demanding instant responses. As a result, a user needs to frequently check his computer for new messages or new events. To relieve the user's burden of constantly checking for new messages or new events, current solutions flash a text description at the corner of a computer screen when a new message or a new event arrives. However, the user can see these indications only if he is at the computer desk, the screen is on, and the mail application is launched. Further, the user must be close enough to the computer to read the text description in order to find out the identity of the sender. In other words, the user cannot know the status of an expected email message if he is in a different part of the room.

### SUMMARY

A method for communicating signals corresponding to messages to an input/output device includes providing a user interface that allows a user to assign one or more signals to one or more characteristics of one or more messages received using a message application. Upon receiving a message, the method determines a characteristic of the message, determines a signal that corresponds to the characteristic of the message, communicates the signal to the input/output device, and activates one or more of a plurality of light emit diodes (LEDs) on the input/output device to generate a colored light corresponding to the signal.

A system for communicating signals corresponding to messages to an input/output device includes a computer that includes a processor executing instructions for providing a user interface that allows a user to assign one or more signals to one or more characteristics of one or more messages received using a message application. The instructions further include, upon receiving a message, determining a characteristic of the message, determining a signal that corresponds to the characteristic of the message, and communicating the signal to the input/output device. The computer further includes the input/output device that includes a plurality of light emit diodes (LEDs). One or more of the plurality of LEDs are activated to generate a colored light corresponding to the signal.

### BRIEF DESCRIPTION OF THE DRAWINGS

Exemplary embodiments of the method and system for communicating signals corresponding to messages to an input/output device will be described in detail with reference to the following figures, in which like numerals refer to like elements, and wherein:

FIG. 1 illustrates exemplary hardware components of a computer that may be used in connection with the method and system for communicating signals corresponding to messages to an input/output device;

FIG. 2 illustrates an exemplary input/output device that includes a plurality of light emit diodes (LEDs);

FIGS. 3 and 4 illustrate exemplary user interfaces for setting up new events;

FIG. 5 is a flow chart illustrating an exemplary method for communicating signals corresponding to messages to the input/output device; and

FIG. 6 shows another exemplary method for communicating a signal corresponding to an identity of a message sender to the input/output device.

### DETAILED DESCRIPTION

Before one or more embodiments of the method and system for communicating signals corresponding to messages to an input/output device are described in detail, one skilled in the art will appreciate that the method and system for communicating signals corresponding to messages to an input/output device are not limited in their application to the details of construction, the arrangements of components, and the arrangement of steps set forth in the following detailed description or illustrated in the drawings. The method and system for communicating signals corresponding to messages to the input/output device are capable of other embodiments and of being practiced or being carried out in various ways. Also, it is to be understood that the phraseology and terminology used herein is for the purpose of description and should not be regarded as limiting.

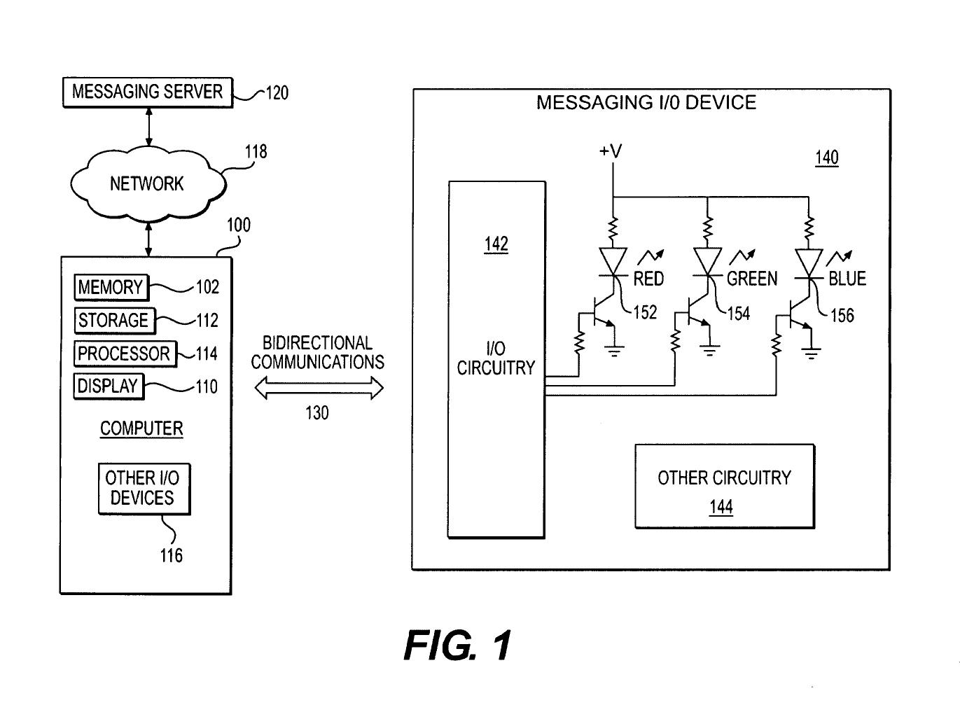

FIG. 1 illustrates exemplary hardware components of a computer 100 that may be used in connection with the method and system for communicating signals corresponding to messages to an input/output device 140.

The computer 100 includes a connection with a network 118 such as the Internet or other type of computer or telephone network. For example, the network 118 connects the computer 100 with a messaging server 120, such as an email server, to obtain information related to a message. The computer 100 typically includes a memory 102, a secondary storage device 112, a processor 114, a display device 110, the input/output device 140 (also referred to as messaging input/output device 140), and other input/output devices 116.

The memory 102 may include random access memory (RAM) or similar types of memory. The secondary storage device 112 may include a hard disk drive, floppy disk drive, CD-ROM drive, or other types of non-volatile data storage, and may correspond with various databases or other resources. The processor 114 may execute instructions to perform the method steps described herein. These instructions may be stored in the memory 102, the secondary storage 112, or received from the Internet or other network 118. The display device 110 may include any type of device for presenting visual image, such as, for example, a computer monitor, flat-screen display, or display panel.

The messaging input/output device 140 and input/output devices 116 may include any input device for entering data into the computer 100, such as a keyboard, keypad, cursor-control device, touch-screen (possibly with a stylus), or microphone, and any type of output device for presenting data in hard copy format and for providing data in audio form, such as a printer or a speaker. The computer 100 may include multiple input devices, output devices, and display devices.

The input/output device 140 may be a mouse (also referred to as messaging mouse or messaging center mouse) or any other device that is capable of inputting data into the computer 100 and displaying a signal to a user. The input/output device 140 bilaterally communicates 130 with the computer 100 using, for example, a universal serial bus (USB). Alternatively, the input/output device 140 communicates 130 with the computer 100 wirelessly, using, for example, Bluetooth technology. The input/output device 140 may be placed remotely from the computer 100. The input/output device 140 includes an input/output circuitry 142, other circuitry 144, and a plurality of light emit diodes (LEDs), such as a RED LED 152, a GREEN LED 154, and a BLUE LED 156. The three LEDs can generate an infinite number of colors by varying the intensity of one or more LEDs to generate a color mix.

Although the computer 100 is depicted with various components, one skilled in the art will appreciate that the computer 100 can contain additional or different components. In addition, although aspects of an implementation consistent with the method and system for communicating signals corresponding to messages to an input/output device are described as being stored in memory, one skilled in the art will appreciate that these aspects can also be stored on or read from other types of computer program products or computer-readable media, such as secondary storage devices, including hard disks, floppy disks, or CD-ROM; a signal embodied in a carrier wave from the Internet or other network; or other forms of RAM or ROM. The computer-readable media may include instructions for controlling the computer 100 to perform a particular method.

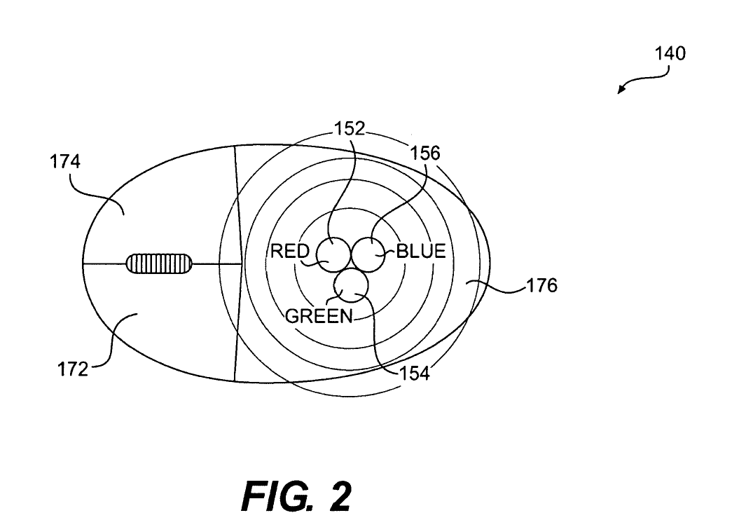

FIG. 2 illustrates an exemplary input/output device 140 that includes LEDs 152, 154, 156. The exemplary input/output device 140 also includes a left button 172, a right button 174, and a mouse body 176 that is translucent on its top and/or one or more sides to display the colored lights generated from the LEDs.

The input/output device 140 may serve as a messaging center. Messaging software may be executed by the processor 114 on the computer 100 to provide instructions to perform the method steps for communicating signals corresponding to messages to the input/output device 140. Alternatively, the messaging software may be executed by a processor (not shown) on the input/output device 140

First, the messaging software provides a user interface that allows a user to assign different colors to important messages, such as an email or instant messaging (IM) message from an individual or a calendar event. The messages are received using, for example, one or more messaging providers, such as Microsoft Outlook, Yahoo Mail, Gmail, Yahoo Messenger, AOL Mail, AIM, and the like. The user may also assign different blink patterns to different messages. For example, email or IM messages may receive a solid pattern, whereas calendar events receive a blink pattern.

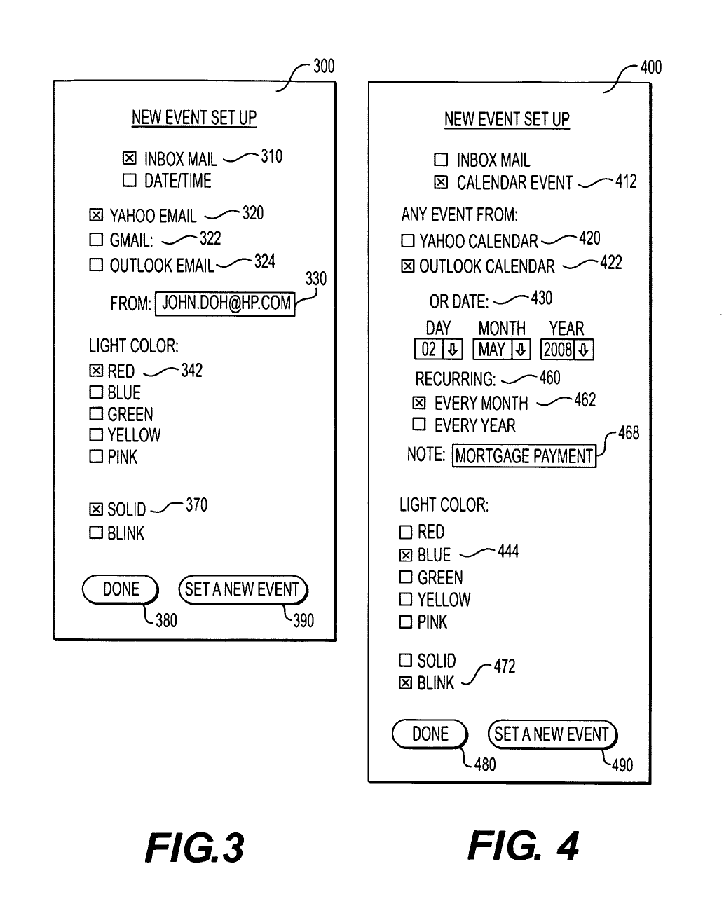

FIGS. 3 and 4 illustrate exemplary user interfaces 300 and 400, respectively, for setting up new events. For example, referring to FIG. 3, the user can assign color RED 342 to an inbox email 310 from John.doh@hp.com 330 arriving on Yahoo Mail 320. The user may optionally assign the same color to email or IM messages sent by the same sender using different messaging providers. For example, inbox mails 310 from John.doh@hp.com 330 will be assigned color RED 342 whether it arrives on Microsoft Outlook 324, Yahoo Mail 320, Gmail 322, or AOL Mail (not shown). Alternatively, the user may assign a certain color to all email messages arriving on a specific messaging provider. For example, any email arriving on Outlook 324 may be assigned color ORANGE (not shown). The user may set a new event 390 using the user interface 300 or may click on “Done” 380 to exit.

Referring to FIG. 4, examples of the calendar event 412 include a payment due date, a birthday of a relative or friend, and an appointment. Such a calendar event 412 may come from Yahoo calendar 420, Outlook calendar 422, or other messaging providers' calendar. The user may, for example, assign color BLUE 444 to May 2, 2008, which is mortgage payment due date 468. The event in this example happens every month 462 and is recurring 460. Events may occur at various frequencies including every year, every week, and every two weeks. In this example, the calendar event 412 is assigned a blink pattern 472. The user may assign different patterns to an event, such as a solid pattern (grayed out in FIG. 4) and various blink patterns. The user may set a new event 490 using the user interface 400 or may quit by clicking on “Done” 480.

The messaging software can run in the background to detect when a new message arrives. Upon receiving a message, the messaging software determines a characteristic of the message, such as an identity of an email or IM sender or a calendar event. The identity of an email or IM sender may be determined by matching the email or IM address of the sender with a profile saved on the messaging provider's database. The messaging software may ask the user to provide a user name and password in advance to access the messaging server to obtain the profile.

Next, the messaging software determines a signal that corresponds to the characteristic of the message. The signal may be a specific color and a blink pattern assigned by the user. Using the above examples, when an email from John.doh@hp.com arrives on Yahoo Mail, the messaging software determines that the signal is RED with a solid pattern. Likewise, when the date of May 2, 2008 arrives, the messaging software determines that the signal is BLUE with a blink pattern.

The messaging software then communicates the signal to the input/output device 140 and activates one or more of the LEDs on the input/output device 140 to generate a colored light corresponding to the signal. The color of the light is generated by a certain mix of the RED, GREEN, and BLUE light intensities, which can form an infinite number of colors. The three LEDs are close to each other to form the required color mix. The colored light shines through a translucent top and sides of the input/output device 140. As a result, the user can determine, at a distance from the computer 100, the sender of an email and an important date, by observing the color and blink pattern of the light on the input/output device 140. The user can be notified of the existence of important messages even when he is not sitting in front of the computer or the computer's screen is blanked.

More then one message can be shown at once by sequentially changing the colored light from one color to another until a reset is activated by the user. Email is used as an example, but the colored signal light can be used for different types of messaging.

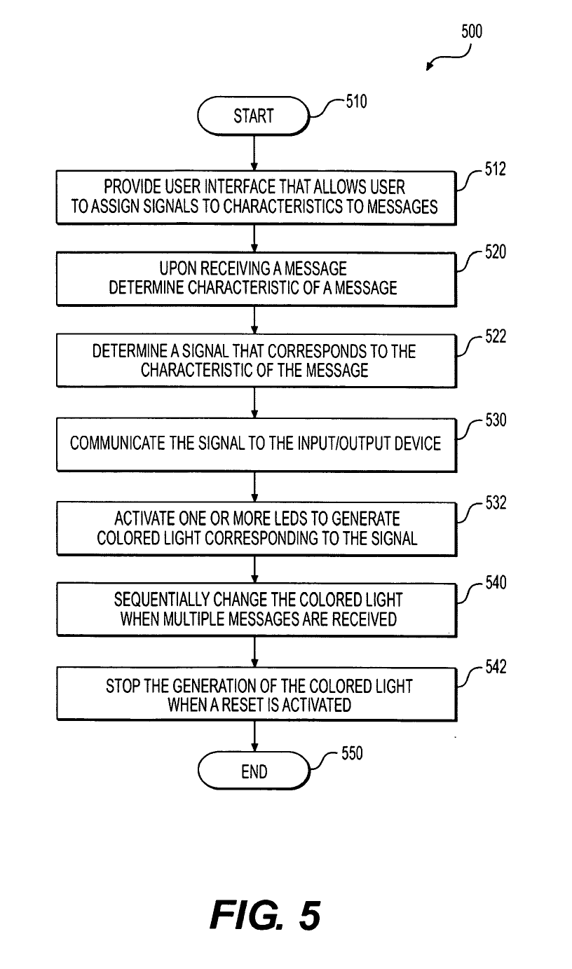

FIG. 5 is a flow chart illustrating an exemplary method 500 for communicating signals corresponding to messages to the input/output device 140. The method 500 starts 510 by providing a user interface that allows a user to assign one or more signals to one or more characteristics of one or more messages received using a message application (block 512). Next, upon receiving a message, the method 500 determines a characteristic of the message (block 520), determines a signal that corresponds to the characteristic of the message (block 522), communicates the signal to the input/output device (block 530), and activates one or more of the plurality of LEDs on the input/output device to generate a colored light corresponding to the signal (block 540). The method 500 may sequentially change the colored light when multiple messages are received (block 540). The method 500 stops generating the colored light when a reset is activated (block 542). The method 500 ends at 550.

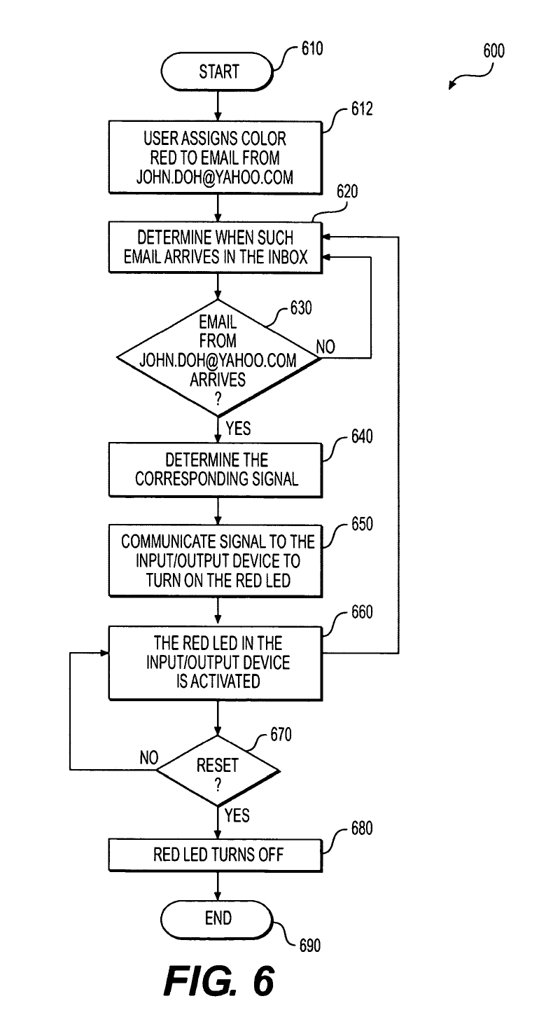

FIG. 6 is a flow chart illustrating an exemplary method 600 for communicating a signal corresponding to an identity of a message sender to the input/output device 140. The method 600 starts 610 by allowing a user to assign, for example, color RED to emails from John.doh@yahoo.com (block 612). The method 600 determines when such an email arrives in the inbox (block 620). If an email from John.doh@yahoo.com arrives (block 630), the method 600 determines the corresponding signal (block 640) and communicates the signal to the messaging mouse 140 to turn on the RED LED 152 (block 650). The RED LED 152 in the messaging mouse 140 is activated (block 660). The method 600 continues to generate the RED LED 152 until a reset is activated (block 670) and the RED LED is turned off (block 680). The method 600 ends at 690.

In the foregoing detailed description, systems and methods in accordance with embodiments of the method and system for communicating signals corresponding to messages to an input/output device are described with reference to specific exemplary embodiments. Accordingly, the present specification and figures are to be regarded as illustrative rather than restrictive. The scope of the method and system for communicating signals corresponding to messages to an input/output device is to be further understood by the numbered examples appended hereto, and by their equivalents.

Further, in describing various embodiments, the specification may present a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A computer-implemented method for communicating signals corresponding to messages to an input/output device, comprising:
providing a user interface that allows a user to assign one or more signals to one or more characteristics of one or more messages received using a message application;
upon receiving a message, determining a characteristic of the message;
determining a signal that corresponds to the characteristic of the message;
communicating the signal to the input/output device; and
activating one or more of a plurality of light emit diodes (LEDs) on the input/output device to generate a colored light corresponding to the signal.

2. The method of claim 1, wherein the activating step further includes generating a display pattern corresponding to the signal, and wherein the display pattern includes a solid pattern and a blink pattern.

3. The method of claim 1, wherein the input/output device is a mouse.

4. The method of claim 3, wherein a top and one or more sides of the mouse are translucent to display the colored light.

5. The method of claim 1, wherein the plurality of LEDs include a red LED, a green LED, and a blue LED.

6. The method of claim 5, further comprising varying an intensity of each of the red LED, the green LED, and the blue LED to generate the colored light.

7. The method of claim 1, wherein the communicating step includes using a universal serial bus (USB) connection to communicate the signal to the input/output device.

8. The method of claim 1, wherein the communicating step includes communicating the signal wirelessly to the input/output device.

9. The method of claim 1, wherein the input/output device is a device that is located remotely from a computer on which the user interface is located.

10. The method of claim 1, wherein the characteristic of the message includes an identity of an email sender, and wherein the determining the characteristic step includes determining the identity of the email sender by matching an email address of the email sender with a profile saved on the messaging provider's database.

11. The method of claim 10, wherein the determining the characteristic step further includes accessing an email server of the messaging provider to determine the identity of the email sender using an account name and a password.

12. The method of claim 1, wherein the characteristic of the message includes an identity of an instant messaging (IM) sender, and wherein the determining the characteristic step includes determining the identity of the IM sender by matching an IM address of the IM sender with a profile saved on the messaging provider's database.

13. The method of claim 1, wherein the characteristic of the message includes a calendar event.

14. The method of claim 1, further comprising sequentially changing the colored light from one color to another when multiple messages are received.

15. The method of claim 1, further comprising stopping the generation of the colored light when a reset is activated.

16. The method of claim 1, wherein the plurality of LEDs are situated approximate one another to generate a color mix that corresponds to the signal.

17. A system for communicating signals corresponding to messages to an input/output device, comprising:
a computer comprising:
a processor executing instructions for:
providing a user interface that allows a user to assign one or more signals to one or more characteristics of one or more messages received using a message application;
upon receiving a message, determining a characteristic of the message;
determining a signal that corresponds to the characteristic of the message; and
communicating the signal to the input/output device; and
the input/output device that includes a plurality of light emit diodes (LEDs),
wherein one or more of the plurality of LEDs are activated to generate a colored light corresponding to the signal.

18. The system of claim 17, wherein one or more of the plurality of LEDs are activated to generate a display pattern corresponding to the signal, and wherein the display pattern includes a solid pattern and a blink pattern.

19. The system of claim 17, wherein the characteristic of the message includes an identity of an email sender, and wherein the computer determines the identity of the email sender by matching an email address of the email sender with a profile saved on the messaging provider's database.

20. A computer readable medium providing instructions for communicating signals corresponding to messages to an input/output device, the instructions being executed on a computer and comprising:
providing a user interface that allows a user to assign one or more signals to one or more characteristics of one or more messages received using a message application;
upon receiving a message, determining a characteristic of the message;
determining a signal that corresponds to the characteristic of the message;
communicating the signal to the input/output device; and
activating one or more of a plurality of light emit diodes (LEDs) on the input/output device to generate a colored light corresponding to the signal.
